(19) United States
(12) Patent Application Publication
(10) Pub. No.: US 2002/0174222 A1
(43) Pub. Date: Nov. 21, 2002

(54) Behavior experts in e-service management

(76) Inventor: Earl D. Cox, Morrisville, NC (US)

Correspondence Address: Larson & Associates, P.C., 221 East Church Street, Frederick, MD, 21701-5405, US

(21) Appl. No.: 10/032,967

(22) Filed: Oct. 26, 2001

Related U.S. Application Data
(60) Provisional application No. 60/243,469, filed on Oct. 27, 2000.

(51) Int. Cl. G06F 15/173; G06F 15/16; G06F 9/44

(52) U.S. Cl. 709/224; 709/206; 717/104

(57) ABSTRACT

A method and system is described that determines, by a behavior expert, the performance of an infrastructure component based on the observation data relevant to the operational status of the infrastructure component. The behavior expert instantiates the values of a set of internal variables based on the observation data. It then transforms zero or more of its internal states according to a set of metric rules, employed internally by the behavior expert, based on the values of the instantiated variables. The updates in states may then trigger the generation of zero or more events, indicating the performance of the infrastructure component, according to a set of behavior rules, employed by the behavior expert.

The instant utility patent application claims the benefit of the filing date of Oct. 27, 2000 of earlier pending provisional application 60/243,469 under 35 U.S.C. 119(e).

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

1. Field of the Invention

Aspects of the present invention relate to the field of e-commerce. Other aspects of the present invention relate to a method and system to intelligently manage an infrastructure that supports an e-service business.

2. General Background and Related Art

The expanding use of the World-Wide Web (WWW) for business continues to accelerate and virtual corporations are becoming more commonplace. Many new businesses, born in this Internet Age, do not employ traditional concepts of physical site location (bricks and mortar), on-hand inventories and direct customer contact. Many traditional businesses, who want to survive the Internet revolution are rapidly reorganizing (or re-inventing) themselves into web-centric enterprises. In today's high-speed Business-to-Business (B2B) and Business-to-Customer (B2C) eBusiness environment, a corporation must provide high quality service, scale to accommodate exploding demand and be flexible enough to rapidly respond to market changes.

The growth of eBusiness is being driven by fundamental economic changes. Firms that harness the Internet as the backbone of their business are enjoying tremendous market share gains—mostly at the expense of the unenlightened that remain true to yesterday's business models. Whether it is rapid expansion into new markets, driving down cost structures, or beating competitors to market, there are fundamental advantages to eBusiness that cannot be replicated in the “brick and mortar” world.

This fundamental economic shift, driven by the tremendous opportunity to capture new markets and expand existing market share, is not without great risks. If a customer cannot buy goods and services quickly, cleanly, and confidently from one supplier, a simple search will divulge a host of other companies providing the same goods and services. Competition is always a click away.

eBusinesses are rapidly stretching their enterprises across the globe, connecting new products to new marketplaces and new ways of doing business. These emerging eMarketplaces fuse suppliers, partners and consumers as well as infrastructure and application outsourcers into a powerful but often intangible Virtual Enterprise. The infrastructure supporting the new breed of virtual corporations has become exponentially more complex—and, in ways unforeseen just a short while ago, unmanageable by even the most advanced of today's tools. The dynamic and shifting nature of complex business relationships and dependencies is not only particularly difficult to understand (and, hence manage) but even a partial outage among just a handful of dependencies can be catastrophic to an eBusiness'survival.

Businesses are racing to deploy Internet enabled services in order to gain competitive advantage and realize the many benefits of eBusiness. For an eBusiness, time-to-value is so critical that often these business services are brought on-line without the ability to manage or sustain the service. eBusinesses have been ravaged with catastrophe after catastrophe. Adequate technology, to effectively prevent these catastrophes, does not exist.

eBusiness infrastructures operate around the clock, around the globe, and constantly evolving. If a critical supplier in Asia cannot process an electronic order due to infrastructure problems, the entire supply chain may come to a grinding halt. Who understands the relationships between technology and business processes and between producer and supplier? Are they available 24 hours a day, 7 days a week, 365 a year? How long will it take to find the right person and rectify the problem? The promise of B2B, B2C and eCommerce in general will not be fully realized until technology is viewed in light of business process to solve these problems.

Web-enabled eBusiness processes effectively distill all computing resources down to a single customer-visible service (or eService). For example, a user interacts with a web site to make an on-line purchase. All of the back-end hardware and software components supporting this service are hidden, so the user's perception of the entire organization is based on this single point of interaction. How can organizations mitigate these risks and gain the benefits of well-managed eServices?

Never before has an organization been so dependent on a single point of service delivery—the eService. An organization's reputation and brand depend on the quality of eService delivery because, to the outside world, the eService is the organization. If service delivery is unreliable, the organization is perceived as unreliable. If the eService is slow or unresponsive, the company is perceived as being slow or unresponsive. If the Service is down, the organization might as well be out of business.

Further complicating matters, more and more corporations are outsourcing all or part of their web-based business portals. While reducing capital and personnel costs and increasing scalability and flexibility, this makes Application Service Providers (ASPs), Internet Service Providers (ISPs) and Managed Service Providers (MSPs) the custodians of a corporation's business. These “xSPs” face similar challenges—delivering quality service in a rapid, cost efficient manner with the added complication of doing so across a broad array of clients. Their ability to meet Service Level Agreements (SLAs) is crucial to the eBusiness developing a respected, high quality electronic brand—the equivalent of prime storefront property in a traditional brick and mortar business.

The Internet enables companies to outsource those areas in which the company does not specialize. This collaboration strategy creates a loss of control over infrastructure and business processes between companies comprising the complete value chain. Partners, including suppliers and service providers must work in concert to provide a high quality service. But how does a company control infrastructure which it doesn't own and processes that transcend its' organizational boundaries? Even infrastructure outsourcers don't have mature tools or the capability to manage across organizational boundaries.

The underlying problem is not lack of resources, but the misguided attempt to apply yesterday's management technology to today's eService problem. As noted by Forrester Research, “Most companies use ‘systems’ management tools to solve pressing operational problems. None of these tools can directly map a system or service failure to business impact.” To compensate, they rely on slow, manual deployment by expensive and hard-to-find technical personnel to diagnose the impact of infrastructure failures on service delivery (or, conversely, to explain service failures in terms of events in the underlying infrastructure). The result is very long time-to-value and an unresponsive support infrastructure. In an extremely competitive marketplace, the resulting service degradation and excessive costs can be fatal.

### BRIEF DESCRIPTION OF THE DRAWINGS

The present invention is further described in the detailed description which follows, by reference to the noted drawings by way of non-limiting exemplary embodiments, in which like reference numerals represent similar parts throughout the several views of the drawings, and wherein:

FIG. 1 shows a high level description about the input and output of a behavior expert;

FIG. 2 describes in more detail the internal structure of an behavior expert and the relationship between the behavior expert and outside world;

FIG. 3 shows a high level block diagram of a local service management system;

FIG. 4 illustrates the internal organization of a behavior expert;

FIG. 5 shows the process of behavior analysis within a behavior expert;

FIG. 6 illustrates the relationship among GDS, the BeXs, and the GDOs;

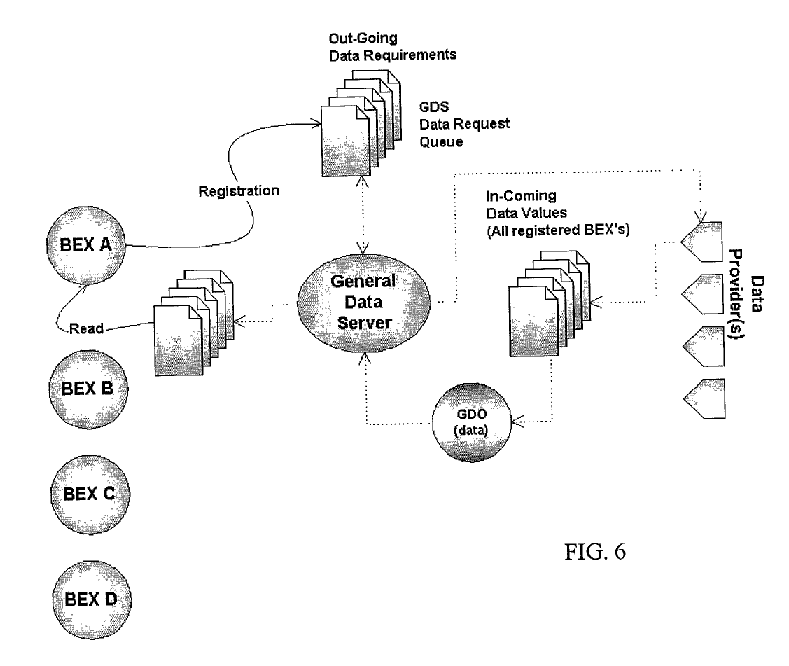

FIG. 7 illustrates how the data move moves from data providers to the rules and ultimately triggers events;

FIG. 8 shows the organization of BeX variables;

FIG. 9 shows a high level organization of a local service manager and the BeX compiler;

FIG. 10 shows how a behavior rules generates an event based on states;

FIG. 11 illustrates how different BeXs can be linked based on a variety of internal controls;

FIG. 12 illustrates fundamental concepts of building a dependency network;

FIG. 13 shows an dependency relationship is created by sharing controls among BeXs;

FIG. 14 describes exemplary topologies created by dependency relationships;

FIG. 15 illustrates ways of building complex, multi-tiered analysis systems;

FIG. 16 illustrates how BeXs share information through the use of a blackboard server;

FIG. 17 is a general block diagram for the adaptive feedback mechanism;

FIG. 18 illustrates a more detailed diagram, in which Adaptive BeXs are used for adaptive feedback control; and

FIG. 19 shows an example of adaptive feedback control.

### DETAILED DESCRIPTION

An embodiment of the invention is illustrated that is related to behavior experts to be used in an eService management system. The present invention enables intelligent eService management by incorporating the knowledge about eService business process into behavior experts at different levels of the eService management in a distributed fashion so that the eService business model dictates the infrastructure management strategy to ensure eService delivery.

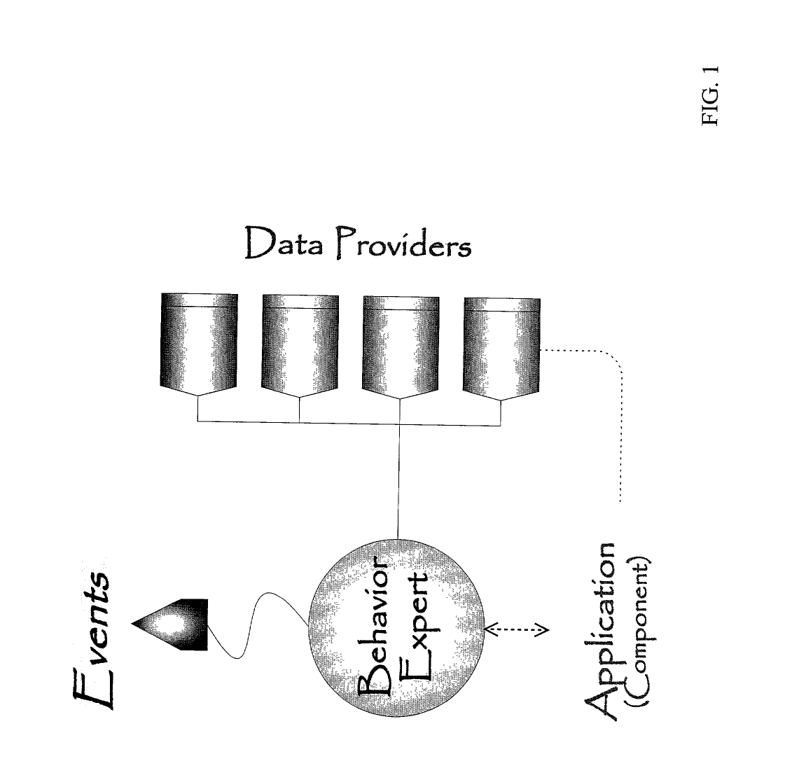

A Behavior Expert (BeX) is a distributed, autonomous intelligent agent in a eService management system, designed to detect, analyze, predict, and control certain behavior of the components of a business infrastructure that supports an eService. A BeX may be attached to a component (or application) of an infrastructure that supports an eService so that the operational status or the behavior of the component may be dynamically monitored and adaptively adjusted to optimize the eService performance. FIG. 1 illustrates a BeX.

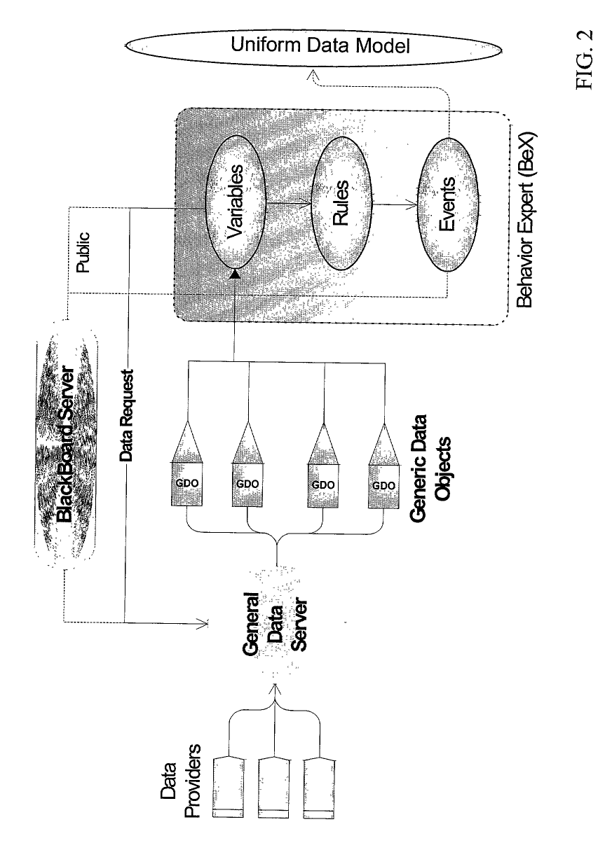

In FIG. 1, a BeX is attached to an application or component. A BeX may analyze a wide spectrum of sensor data from a set of data providers (acquired from the components) and make decisions about the behavior of the components. Component behavior is detected based on a collection of rules. FIG. 2 shows in more detail the construction of a BeX and its connections with other parts of an eService Management System. In FIG. 2, observation data acquired by data providers are sent to a General Data Server. GDS generates generic Data Objects. A BeX is constructed based on a set of variables, states, events, and rules. Rules use variables as their basic building blocks. These variables are populated from GDOs generated by GDS (which, in turn, receives data from data providers). When abnormal behavior is detected, the BeX generated a set of events that are formatted in Uniform Data Model. Such events may be shared with other BeXs through a blackboard server where the BeX may post its events.

Rules employed by a BeX may be non-procedural and are used by the BeX's own inference engine to assemble evidence in order to pursue goals. Each BeX implements a model of application metrics. A collection of BeXs may interact with one another in a dynamic fashion and together it comprises a model of operational and performance metrics for the complete system. Such interactions form flexible topologies among BeXs to enable multi-tiered, aggregated, and meta-analytic analysis under a multi-stage BeX architecture.

There may be various kinds of BeXs. For example, a BeX can be a physical (or coupled) BeX, a logical BeX, or a functional BeX. A physical or coupled BeX is attached to a running component in the infrastructure. This may be the most common form of a BeX. A physical BeX is a behavior module that tracks and responds to the changes in performance of the running component through a series of metrics.

A logical BeX uses the information from other BeXs to analyze the performance of a component collective. The dependency on the information from other BeXs may be described by a dependency tree and a logical BeX may correspond a node locus in the dependency tree.

A functional BeX is a behavior expert that specializes in a particular task. It acts like a small program and is called from another BeX through one of two methods: a traditional CALL <BeXid> or the functional form: <x>=BeXid(parm₁,parm₂, . . . , parmₙ), where BeXid is used to uniquely identify a BeX and parm₁,parm₂, . . . , parmₙ. are the parameters passed to the functional BeX. Functional BeXs provide repositories of distributed and shared knowledge, establish business process modeling support, and encapsulate service policies within the organization.

A BeX can perform a variety of actions, including sending events (messages) to other BeXs, to local and global intelligence centers of the eService management system, as well as directly to the eService management front-end. They play a pivotal role in an eService management system and implement the business process modeling support for the eService at various levels of details.

A BeX attached to a particular running component in an e-service infrastructure performs behavior analysis through a collection of variables and rules that are associated with the running component. A BeX acts on the variable, usually instantiated by the observations acquired from the running component and detects any behavior that is not acceptable according to rules. Such a BeX contains not only a dictionary of the variables but also the transitional states and the rules that carry out the transitions from variables to states and from states to events. A rule defines some violation of acceptable behavior and may take the form:

name. if-premise then action else action;

where “name” is the identifier of a particular rule, “if-premise” describes a condition, “then action” describes the action to be taken when the condition satisfies, and “else action” describes the action to be taken when the condition does not satisfy.

The rules may be designed to enforce the performance requirements, imposed on all the running components of an eService infrastructure to support the e-service. Therefore, the eService business process model, through such requirements, dictates how an eService management carries out its tasks by making all levels of eService management (including BeXs) aware of the purpose and the impact of the infrastructure with respect to the eService.

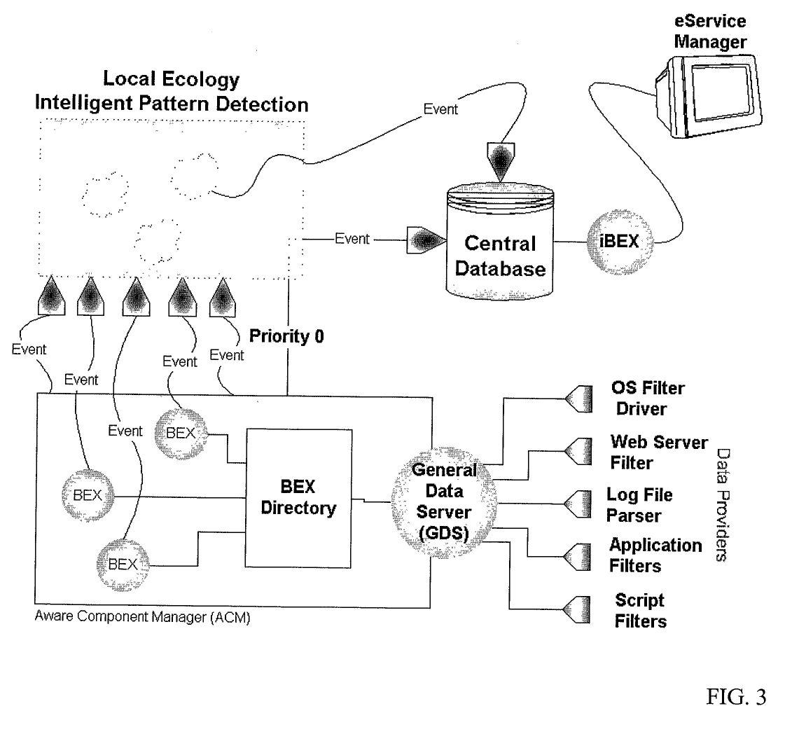

FIG. 3 shows how BeXs interact with other parts of an eService management system. Data providers send observation data to the General Data Server. GDS makes observation data accessible to the BeXs in a uniform object form (Generic Data Object). Each BeX is connected to a General Data Server from where the observation data from infrastructure components can be accessed. Each BeX acts upon the observation data, updates states of the running components that it is managing, and generates events. Such events are the results of behavior analysis performed by the BeX and reflect the behavior of the running components.

BeXs communicate with the outside world through a family of coherent, well-formulated events. These events combine explicit rule-centric information with implicit information available to the BeX in its current state. Events are either shared among the BeXs in the same system or routed into the Local Ecology Pattern Detector. This mechanism either dispatches the event directly to the eService layer (if it has a very high priority) or it absorbs the event and uses it to build clusters of emerging patterns.

Both singleton events (those that pass directly through Local Ecology Pattern Detector) and composite events (those that represent ecological patterns and detected by Local Ecology Pattern Detector) are routed through the dispatcher and stored in a Global Data Repository. These events are read by the integration BeX using the database data provider pipeline. The iBeX incorporates high level intelligence to compute a service level indicator.

We note that there are, in fact, two kinds of Events that can reach the eService Manager from the local service manager (the internal, machine resident collection of BeXs). The first is any event with a high priority. Such event will be routed through to the eService Management front end. The second is any event that has been initiated by Local Ecology Pattern Detector and represents an anomalous pattern. These events are component or process specific, but, nevertheless, represent an aggregate of many individual events. The eService Management front-end may need to distinguish between the two.

Each BeX incorporates (or includes) a collection of data sources. These data sources expose all the underlying metrics available on that platform and for the applications or services running on that platform. The data source definition in a BeX defines the tables of symbolic names used by the variables to couple themselves to the associated data provider. A variable has a set of integral properties: synchronization, data types, name, sapling rate, and the data provider's name.

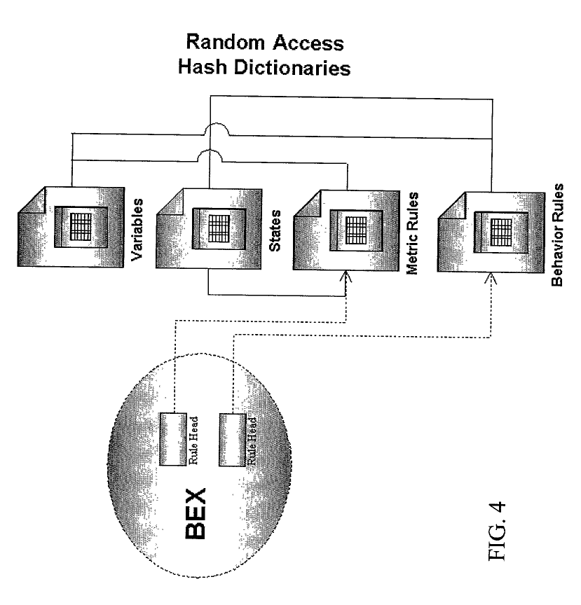

When a BeX receives observation data from GDS, it populates its variables. The updates variable values may trigger the propagation of variable values to a set of States. Such propagation is achieved through a set of metric rules. Furthermore, the changes in States may trigger some events which are detected through a set of behavior rules. FIG. 4 shows how these parts link together in a BeX.

A metric is a threshold violation. Metrics, as the name implies, measure some state of a system (service, component, or application) based on the violation of some specified performance criteria (which may be expressed as a crisp or fuzzy threshold.) In a BeX, metrics are embedded in the premise of a rule. Metrics combine variable values and threshold equations using, for example, crisp or fuzzy operations:

If iCPUTime>80 then CPUALERT=True;

If iCPUTime is veryHigh then CPU_ALERT is Indicated;

Each metric is shown in the “If” clause. The first rule uses a crisp notation. The second rule uses fuzzy sets (veryHigh and Indicated) to describe the threshold states.

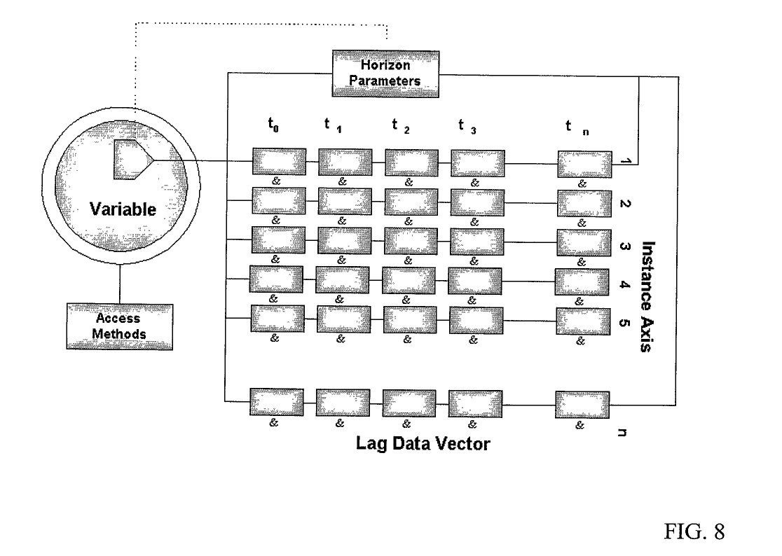

A metric rule is a rule that uses a metric to instantiate (give a value to) a State variable. A metric rule access metric thresholds through the BeX's variables (which are pipelines via the GDS to the underlying data providers). As FIG. 8 illustrates, metric rules execute to populate States and Behavior rules execute to examine the condition of these States.

Metric rules can only set the value of a State—they cannot initiate messages (events). The frequency with which metric rules are fired is the minimum sampling rate for all the variables used in the collection of rules.

Behavior rules execute to examine the condition of States. Behavior rules may have a name, combine multiple implicit or explicit States, and generate a result (such as sending an event to the eService management front-end). Behavior rules are the core intelligence instrumentation in a BeX. A behavior rule can have an execution frequency as well as an explicit degree of severity.

An event may be a message generated by a behavior rule as an action taken when the condition of the rule is satisfied. There may be various types of events. For example, an event may be one of the following types: hidden, local, or external. The type may be determined by the message's visibility. Hidden events are shared among dependent BeXs. Local events are shared between BeXs and the Local Ecology Pattern Detector, as shown in FIG. 3. External events are routed through the dispatcher to a Global Data Repository so that either the Global Ecology Pattern Detector or the eService management front-end can respond immediately to higher priority events.

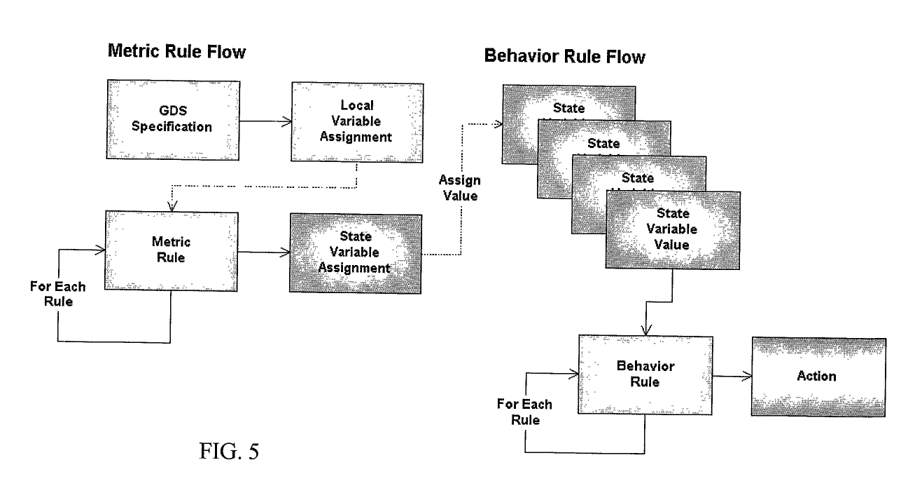

As shown in FIG. 5, events are generated by behavior rules in a BeX. The states are instantiated by metric rules. Behavior rules act on the instantiated states to perform behavior analysis. When conditions of behavior rules are satisfied, the rules are fired to generate events.

Each BeX may be responsible for a different infrastructure component but different BeXs may share information whenever it is necessary. BeXs may share information in different ways. For example, a one-to-many relationship may exist between BeXs. Dependencies among BeXs may form complex topologies in a eService management system. A common use of the dependency specification is the creation of hierarchical or tree structures among BeXs. Other possible topologies can be networks, star patterns, acyclical graphs, and plex structures.

A local eService Management System is the machine resident component of a eService Management system. A local eService Management System connects behavior experts (BeXs) to running applications, tracks the application's performance using metric and behavior logic stored in the BeXs, and communicates any irregularities to the eService Management front-end. Below, aspects of BeXs are described in details.

In FIG. 3, Data Providers are platform specific executables that acquire and deliver information to the General Data Server (GDS). This object handles both synchronous and asynchronous data feeds. Asynchronous feeds (such as the OS Filter Driver) use a form of push technology to send data. Synchronous feeds are coupled to the Aware monitoring software and provide data when called. A scheduler is also used to sample synchronous data on a regular basis. Each BeX is coupled to the General Data Server (which is its only source of data).

BeXs constitute the molecular structure of the eService Management facilities. Each BeX contains four elements: local variable definitions, metric rules, explicit local dependencies, and behavior rules. It is the set of behavior rules that actually affect the generation of events. As an example, a very simple BeX may look something like this:

| | |
|---|---|
| BeXID: | MyBeX |
| CREATED: | 10MAY2000 15:18:12 |
| COMPONENT: | C: \SVER01\SAP2\I\SHOES.EXE |
| DATASOURCE: | SOLARIS1, UNIX |
| COMMONEVENTS: | SHOES.EVE |

//
STATES {

| | |
|---|---|
| Boolean | CPUAlert |
| Boolean | DISKAlert |

}
VARIABLES {

| | | | |
|---|---|---|---|
| Synch int | iCPUUsed | sample 10 | RM.GETCPUTIME |
| Synch int | iDiskRem | | RM.GETDISKLEFT |

}
METRIC RULES {

If iCPUUsed > 80 then CPUAlert = TRUE;
If iDiskRem < 20 then DSKAlert = TRUE;

}
BEHAVIOR RULES {

MyRule1. [Freq 10] If CPUAlert and DskAlert then

Send Event (bAware, aCRITICAL, INSUFFICIENT-RESOURCES, &AppName);

End if

}

The VARIABLES section defines working variables. We need these as “handles” so that we can rules. This section indicates the data type, the variable name, and the data source. The easiest way to identifier the source is simply to specify the GDS method that we could normally use to acquire the data. I can imagine that more advanced features of this section could include sampling rates, filters, arithmetic and logical expressions, and so forth.

The METRIC RULES actually handle the evaluation of thresholds. Metric rules generally implement operational dependencies for the application as well as additional metrics that might be added to observe the application's behavior. The premise described in a metric rule may contain any number of conditions connected by AND or OR to form complex logic. These rules may handle both numeric and string data. String operators include such functions as HAS, CONTAINS, OMITS, LEFT, RIGHT, SUBSTRING, ISIN, TRIM, UPPER, LOWER, FIRST, LAST, THISWORD, GETWORD. The ability to handle string information is important for metrics that look at log files (with these operators we can see if a log file line contains or omits some value, as an example).

The action described in a metric rule is used to set a State Variable. A state may be a Boolean state and can be set to the constant TRUE or FALSE. The default for a State Variable may be set as False. These states are the conditions normally used in the behavior rules to decide whether or not to generate an event.

The BEHAVIOR RULES generate events. In this section we combine the states from the metric rules section. Note that the values of the original variables (and any defined but not used in the METRIC RULES section) are still available in this section, thus allowing these rules to use a wide spectrum of data. The actual event generated depends on the logic of the rule. An event is derived from a more general and flexible message class. This means that it can take a variety of forms. In the previous example, we have the target receptor for the even, the criticality, the event class, and the event message (which in this case is the name of the application inserted as a built-in symbolic variable).

The Behavior Rules section also supports complex logic. Aarbitrarily nested if-then-else rules may be allowed. These rules may normally issue the Send Alert action. However, there is no reason that the result of a rule evaluation could not be the execution of a script, the acquisition of additional data, a change to thresholds (thus we have rudimentary adaptive BeXs), or even the investigation of another BeX's status (how is unknown right now).

When eService Management System discovers an application (or knows that an application is connected), it creates a BeX. The BeX takes the native BeX object, compiles the rules, handles dependencies, thresholds, and data connections, and produces an executable policy that is linked into eService management System's internal Directory of active BeXs. The eService Management System cycles through the BeX objects at some sampling rate. During each cycle all the rules are executed. When some threshold is exceeded (actually, when some rule initiates an action), an event of some class and type can be generated—whether or not an event is dispatched depends on the Behavior Rules logic

A BeX contains two central and inter-connected rule dictionaries. The first rule set, METRIC RULES, defines threshold violations and set global state variables. The second rule set, BEHAVIOR RULES, interprets the state variables established by the Metric Rules and take some action (such as signaling an event notice back to the eService Management System's front-end). FIG. 8 shows the flow of control logic in the two rule sections and illustrates how they are functionally connected.

Metric Rules may be optional (but necessary) components of the BeX. They identify and name specific states within the system. These states have, by default, the External attribute. As we will see later, the implicit dependency relationships among BeXs may work in several modes: variable, states, and rules. In general, the tiering of application performance BeXs is done through the illumination of fired rules in subordinate (dependent) BeXs.

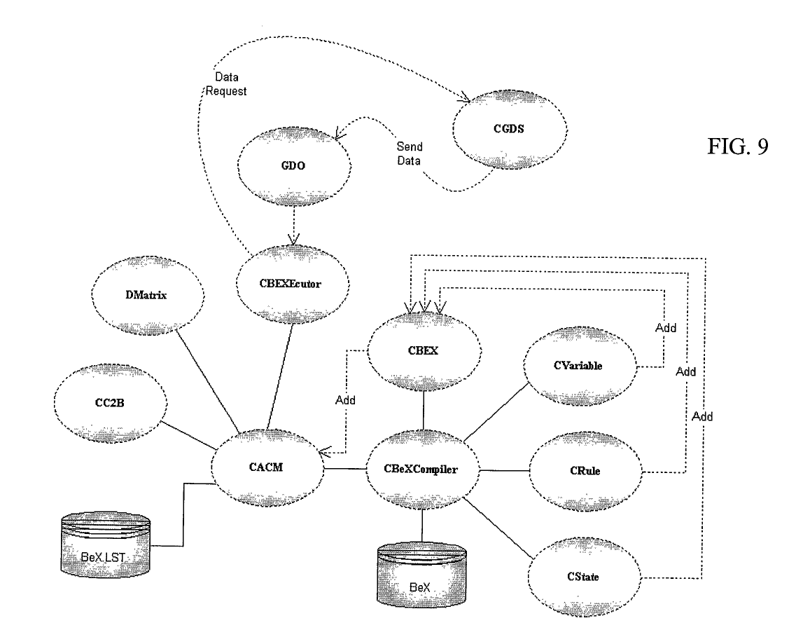

Each Metric Rule is connected to a single General Data Server (GDS) pipe. These pipes are either synchronous or asynchronous (the difference is discussed later). A BeX is compiled and installed in the system as an active, event-driven object. It is attached to the General Data Server through a registration process that identifies its data needs. The set of declared data provider requirements is automatically updated by the GDS based on the sampling or refresh rate of the connection. FIG. 9 illustrates the relationship between the GDS, the BeXs, and the General Data Object (GDO).

The registration process allocates a group of slots (linked nodes) in the GDS that are allotted to and connected to the BeX instance. These nodes will contain the data packages from the GDS that correspond to the data elements requirements during registration. Once connected to the GDS, a BeX listens to the data input buffer (the collection of GDO instances) for data packages that belong to one of its rules. When found, the items are read and the GDO at that slot position is cleared (deallocated).

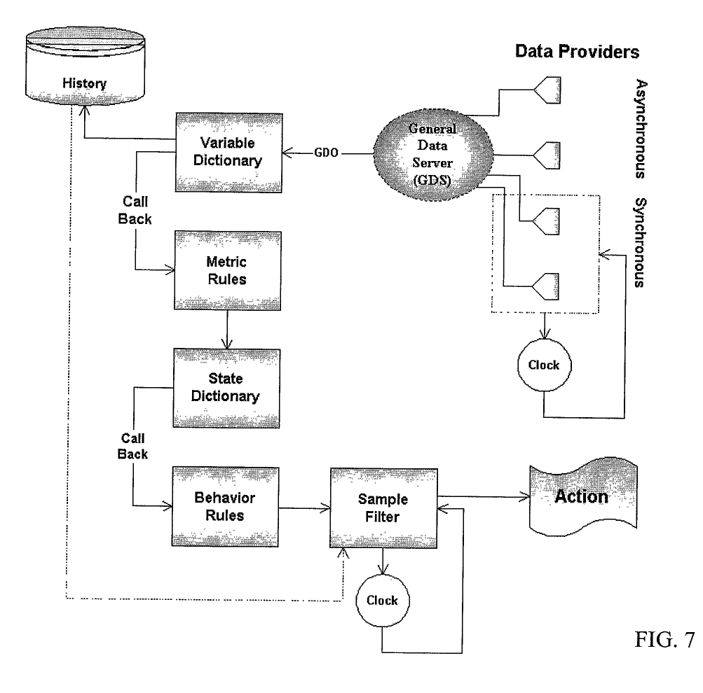

Data flows through a BeX are initiated by the call back methods associated with the BeX's variable dictionary. The General Data Server triggers these methods. FIG. 7 illustrates how the data moves from the data providers through the metric and behavior rules and ultimately can trigger some event.

When a behavior rule emits an event, we check with the sampling filter to see whether or not the event should actually be transmitted. If, as an example, if the rule has a clock filter of 10:6 (10 times in six seconds) then we look at the time since the last event and the count of event generations. If the count is greater than or equal to six and ten seconds have elapsed we send the event, otherwise we simply increment the event counter and leave (no event is sent). When an event is sent, the elapse time and the event counter are reset to zero.

Behavior rules in a BeX are generally not point-in-time productions. Rather, they analyze changes in the application state. These changes are reflected as periodic threshold violations, average violation quantifiers, or some increase or decrease in the change (that is the rate of change or the degree of change). We might have rules that use antecedent expressions like,

If X>1 on a regular basis

If X is increasing

If X is rapidly increasing

If delta(Xₜ,Xₜ₋₁) is large

If X occurs M times in N time periods

If avg(X) is above threshold

Further, the data returned from the data providers is often not a single (scalar) value. Instead, the data provider can return a vector of values. As an example, the resource DiskSpace would returns a vector of 2 tuple value, one tuple for each disk: ((C,201)(D,97)(E,2065)(J,16701)). The cardinality of the vector depends on the number of disks attached to (or visible to) the data provider. This means we will have rules that implicitly or explicitly loop over these vector elements. This means a variable definition such as,

Synch int iDiskSpace() sample 80 dp_nt_rm.diskspace

Produces a multi-dimensional variable. Our rule language must not accommodate an access to these implicit arrays (or matrices). Rules now can take on such forms as:

For iDiskSpace.DiskId(“C”,“D”)

If iDiskSpace.DiskCapacity < 80 then

Sendevent(Urgent,“Out of Disk Space”);

End for

In order to accommodate these kinds of rules, the Behavior Module incorporates two interconnected features: a sampling clock and a matrix of variable data (instances and their historical values). With these two capabilities we can form rules that measure the change in a variable from state to state. This allows the rule handler to detect and predict the state of the system in the current as well as future periods. This capability is also crucial to the workings of the adaptive feedback system.

In order to implement this kind of analysis, we need to introduce a collection of time (or vector) functions into the behavior and metric rules. This necessitates a fundamental change in the way we visualize a variable. Variables are now multi-dimensional time series or linear vector objects with a chronological array of data elements. The horizontal axis holds the historical data. The vertical axis is the instance axis. The dimensionality of horizontal axis is modulo-N, where “N” is the time horizon. We can isolate a particular instance row with the for keyword (the extended form of which includes foreach, forany, and forall). We can index a variable along the horizontal axis with the built-in time index (t) or we can use one of the time access functions to abstract statistical information about the data. FIG. 8 illustrates the organization of a BeX variable.

Many of the functions involve a moveable time horizon window. This window is specified in terms of the timeoffset and the periods parameters. We specify the start of the data value as a timeoffset (thus, 0=most recent or current data value, 1=the last or previous value, 2=the one immediately before the previous, and so forth.) The timeoffset is in the form of a time expression (texp). Thus, t-0 is the current period, t-1 is the previous values, etc.) The texp can be any arithmetic expression that produces a number in the range [0,N−1]. The periods parameters indicates how many periods are used in the calculation. If omitted, the remainder of the time periods starting at the timeoffset is used. Thus, if a variable X has 10 time periods, the expression avg(X,t-4) uses periods [5] thru [9] all time series are zero based.)

| | |
|---|---|
| Avg | avg(varid{, timeoffset{, periods}) Computes the mean or average of the data |
| | vector. |
| Count | count(varid{, timeoffset}) Returns the count of the actual number of values |
| | in the lag data vector beginning at any timeoffset. |
| Frequency | frequency(varid, exp{, timeoffset}{, periods}) Returns the number of times |
| | the value indicated by exp appears in the lag data vector. |
| Last | last(varid{, periods}) Returns the last data value in the time series. |
| Max | max(varid{, timeoffset}{, periods}) Returns the maximum value. |
| Maxfreq | maxfreq(varid{, timeoffset}{, periods}) Returns the number of times the |
| | maximum value in the series appears in the lag data vector. |
| Median | median(varid{, timeoffset}{, periods}) Returns the mediam data value. |
| Min | min(varid{, timeoffset}{, periods}{, threshold}) Returns the minimum value. |
| Minfreq | minfreq(varid{, timeoffset}{, periods}) Returns the number of times the |
| | minimum value in the series appears in the lag data vector. |
| Mode | mode(varid{, timeoffset}{, periods}) Returns the Mode of the data |
| | distribution (note that this is a relatively expensive operation since the lag |
| | data vector must be sorted.) |
| Previous | previous(varid{, timeoffset}) Returns the previous value from the lag data |
| | vector beginning at any specified timeoffset. |
| Regularly | regularly(vexp{, percentage}{, timeoffset}{, periods}) Returns a Boolean |
| | indicating whether or not the variable expression (vexp) when evaluated |
| | against each of the historical values occurs more than the indicated |
| | percentage. As an example, the function, |
| | regularly(iCPUUSE >80, 50) |
| | returns true if the ICPUUSE value in each time period is greater than 80 in |
| | 50% of the cases. The percentage can be used to implement such semantics |
| | as occasionally (>10), often (>25), frequently (>40), usually (>50), mostly |
| | (>75), nearly always (>85) and always (>97). Naturally these numbers are |
| | model dependent and only given as an example. |
| Sdiff | sdiff(varid{, timeoffset}{, periods}) Returns the sum of the differences |
| | between the lag data vector values. |
| Strend | strend(varid{, timeoffset}{, periods}) Returns the slope coefficient for the |
| | series in the range [−1, +1]. This is degree to which a polynomial least-ques |
| | regression line has a positive or negative slope. This is a predictor function. |
| Var[t] | varid[texp] Explicitly selects a cell in the lag data vector using a texp. All |
| | variables have a default selector of var[t], that is, the current value. |

The rule handler also provides several built-in values that describe the current state of the variable and its time series. In some cases these can be used to re-adjust the state of the variable.

| | |
|---|---|
| var.periods | (function) returns the total number of time periods |
| | associated with the variable. |
| Var.time | var.time({begin}{, end}{, slice}) A directive and a |
| | function. Returns the current timeoffset associated with the |
| | variable. As a BeX directive, this also changes the time |
| | horizon used by all the rules that access the associated |
| | variable. Thus X.time(1, 5) restricts all functions to |
| | time period 1 (the previous data) out to time period |
| | five. However, X.time(1, 20, 2) restricts the |
| | variable to periods 1 thru 20 with a step function of 2 |
| | (that is, every other value). X.time(BEGIN) returns |
| | the start X.time(END) returns the ending |
| | period. These are built-in keywords. |
| | X.time() restores the time horizon to |
| | its default values. (We need to see if |
| | this kind of time control is really |
| | necessary before implementing such a complex |
| | control mechanism). |

The rule architecture is consequently affected by this change in the variable structure. Rules must be able to exploit the higher and richer dimensionality of the variables. A rule must also be able to isolate regions within the underlying instance and lag data space. Thus, rules become more script-like in their organization, allowing the designer to loop over the horizontal and vertical axes, perform flow of control operations (for, while, if, until, and do), access elements through subscripts, isolate sub-matrices (with, step, by). We can write a rule such as,

With iDiskSpace.DiskId(&ThisApp.ResidentDiskId)
{

if iDiskSpace.DiskCapacity < 80 then SendEvent();
if iDiskSpace.PctFull > 90 then SendEvent();

}

Note that the first sub-rule sends an event when it finds a disk with a storage capacity of less than 80 Megabytes (not the available remaining space, which would be the method, RemainingSpace). Rule work with implicit looping over any unrestricted dimension. Thus, the statement,

if Avg(iDiskSpace) . . .

Takes the average disk space of the entire NxM data matrix. On the other hand, a statement such as,

For iDiskSpace.DiskId(“C”)

if Avg(iDiskSpace) . . .

Computes the average disk space only for the C: disk. And,

For iDiskSpace.DiskCapacity>50

if Avg(iDiskSpace) . . .

Computes the average disk space for all the disks with an available capacity of over 50 Megabytes.

To implement this feature Variables need an historical array of data. Rules also need a frequency histogram (or other such pattern recognition feature) to record the number of events issued within their frequency time frame. The predicate clock or sampling calculation must also match both the frequency of the rules and the sampling rate of the variable

FIG. 9 shows the high level organization of a local service manager and the BeX Compiler (which generates the BeX objects stored in the local service manager's directory).

The implicit information comprises the BeX identification, the Node (location of service), the date/time stamp, the rule identifier, and the rule's degree of truth. Explicit event information provides categorization and classification information necessary to aggregate or summarize information. Each event has four related attributes:

| | |
|---|---|
| Group | The fundamental type of the event. This can one of the |
| | following symbolic constants: MAINT, PERFORM, and |
| | INTERNAL, The Maintenance Group specifies events |
| | that are not related to the issues of performance |
| | (thresholds and metrics). The performance Group is |
| | the principle event family dealing with behavior violations and |
| | notices. This is the Group of events that is principally |
| | intercepted by LECO and also used by the eServices Manager |
| | to control the display of status in the model hierarchy. The |
| | Internal Group are events that are intended for dependent |
| | BeXs within the same machine or server environment. |
| Class | The class of event information. There are five intrinsic |
| | (built-in) classes: OS, APP, SYSTEM, NET, XTRAN. The |
| | user can define additional event classes. |
| Measure | Within the class, the type of measure. There are six |
| | intrinsic (built-in) measures: AVAIL, VOLUME, RESPTIME, |
| | TRANRATE, THRUPUT, and FAULTS. The user can define |
| | additional event measurement types. |
| Specificity | The ClassxMeasure couplet can also be qualified according to |
| | its analytical specificity. There are two possible values |
| | along this axis: QUALITATIVE and QUANTITIATIVE (also |
| | specified as WEAK and STRONG). Specificity is also |
| | a factor in the use of fuzzy rules indicating the possible |
| | degree of elasticity |
| | in the model measurement. |

The following matrix shows the relationship between Class and Measure. Although these are organized in a matrix, not all relationships might be valid—this might, as an example, be particularly true of the SYSTEM (the system call driver data stream).

| Measure | | | RESP- | TRAN- | TRHU- | |
|---|---|---|---|---|---|---|
| Class | AVAIL | VOLUME | TIME | RATE | PUT | FAULTS |
| OS | | | | | | |
| APP | | | | | | |
| SYSTEM | | | | | | |
| NET | | | | | | |
| XTRAN | | | | | | |

The fundamental characteristics of an event is specified in the Events section of the BeX. Each BeX can establish its own vocabulary of events and it can also include a global or shared definition of common events. A collection of global or commonly shared events can be specified in the CommonEvents section of the header. Like the DataSources specification this statement indicates a collection of previously defined and shared event definitions. To declare an event, we give it a unique name and declare its properties. The general syntax is:

Events.

eventid Group,Class,Measure,Specificity “message”

where message indicates the information string that is transmitted with the event. If a message text is not specified, it can be included in the actual event action of the rule (see blow). With this kind of declaration we can then use the SendEvent action of the behavior rule language to complete an event and send it to either the eServices layer or to the LECO pattern organizer. The SendEvent action has the following general syntax,

SendEvent(eventId, priority, severity {,message})

Where,

| | |
|---|---|
| eventId | (string) The identifier of the event as it occurs in the Events |
| | section of the BeX (or as it occurs in the CommonEvents header |
| | include file.) Only events that have been defined in these two |
| | regions can be transmitted by the SendEvent rule action. |
| priority | (integer, [0, 10]) is the urgency of the event. The smaller the |
| | number, the higher the priority. This event parameter affects the |
| | way the event is handled by the local ecology system. A priority |
| | of zero (0) is automatically routed directly though LECO to the |
| | eService database for immediate action. All other priority events |
| | are held by LECO where they are classified and used in the |
| | emerging pattern analysis (where priority plays an important |
| | role in the way patterns are interrelated.) |
| severity | (float, [0, 1] or [0, 100], psychometric scaling) The degree of |
| | “damage” associated with this event (used primarily with |
| | PERFORM group events, but not restricted to this group). The |
| | severity is a measure along the psychometric scale of the impact |
| | this rule firing has on the performance of the associated |
| | component (or, for a logical or virtual BeX, on the |
| | performance of the composite system.) With the addition |
| | of fuzzy behavior rules in the near future |
| | this severity will be the product of the defuzzified solution scalar |
| | vector and the degree of evidence in the solution (the |
| | compatibility index of the solution fuzzy vector). |
| message | (string) A text message describing the event. If a message |
| | was not declared with the event, it can be added as a parameter |
| | in the action. |
| | If a message exists with the declared event, this message will |
| | replace the defined text (unless the text starts with a plus |
| | “+” sign, in which case it is appended to the declared |
| | text.) |

When a behavior rule is fired (its premise or antecedent conditions are true), we can send an event notice to the Aware front-end. This notice is used by such functions as eServices Manager to illuminate system problems. In addition to the explicit information associated with an event (the combination of the event declaration properties and the SendEvent parameters), the event also contains a compacted collection of internal or implicit data. This is provided automatically by the SendEvent operation. The following layout provides a complete description of the emitted transaction.

| | |
|---|---|
| Sema- | (Byte) Indicates the aggregation methodology used for |
| phore | this event. |
| Time | (string) The date/time stamp for the event. This maintains |
| | chronological order in the bDB database. The data in the form |
| | yyyymmddhhmmss. |
| Node | (integer) Location of the service |
| Compo- | (string) The application throwing the event. This is the name |
| nent | of the application monitored by the Behavior Module. |
| BeXId | (string) The identification of the BeX throwing the event. An |
| | application may have multiple BeXs, thus we need to know |
| | exactly which BeX is reporting this event. |
| Group | (integer) The symbolic constant value. |
| Class | (integer) The symbolic constant value. |
| Measure- | (integer) The symbolic constant value. |
| ment | |
| Prior- | (integer) |
| ity | |
| RuleId | (string) The identification of the Rule in the BeX that fired (or |
| | didn't fire - see next column of data). |
| Severity | (float) |
| Degree | (float, [0, 1]) Used with fuzzy inferencing. Reflects the |
| | degree of evidence used to develop the Severity level. |
| Data | (string) A package of data associated with the rule |
| | execution. This is the expanded rule buffer. By “expanded” |
| | we mean that the value of the variables are encoded with |
| | the rule. Thus, for a rule fragment such as, |

if iCPUAvail < 100 then . . .

the Buffer would contain,

if iCPUAvail {80} < 100 then . . .

in this way the receiving interface, if necessary, can parse
out the actual values that triggered the rule. Braces are used
since these are not valid lexical elements in the rule syntax.

A reference to a GDS pipe is through a locally defined and explicitly typed variable. A variable can be dynamic (dv), external (dx), or static (sv). Static variables have values that persist through subsequent executions of the behavior Module (and thus can be used as accumulators or for other kinds of global control). Variables are explicitly defined before any of the Metric rules. A variable definition has the form:

(Push Type) StorageType Data Type VarId (SampleRate) GDSpipe

Where:

| | |
|---|---|
| Push- | is the availability scheduling mechanism associated with the |
| Type | variable. This can be Synchronous or Asynchronous (or |
| | Synch and Asynch). If not specified then Synchronous is |
| | assumed by default. |
| Storage- | is the optional storage class designator (Dynamic, External, |
| Type | Shared, or Static). If not specified, Dynamic is assumed. A |
| | Dynamic variable is local to the BeX and is always attached to |
| | an data provider source through the GDS pipeline. A Static |
| | variable is local to the BeX, is initialized when the BeX is |
| | compiled and loaded, and is generally not attached to a data |
| | source. An External variable is visible to all the BeXs in the |
| | active Aware system. An External variable can be referenced in |
| | another BeX, however, it must have the Shared data type |
| | designator in all but the original BeX. |
| Data | is the type of data this variable can hold. The variable types |
| Type | can be integer (int), string, float, double, or Boolean. Each |
| | variable must have an explicit data type specification. |
| VarId | is the name of the variable. The name can be one to thirty-two |
| | characters in length (and must start with either the |
| | underscore or an alphabetic character). Variable names are |
| | not case sensitive. Each variable name in the BeX must be |
| | unique. If the variable name has the external data storage |
| | attribute, it must be declared as shared by all other BeXs |
| | except the one where it is originally defined. A static |
| | and external variable can also have an initialization |
| | value (this value is assigned only once - when the BeX is |
| | compiled and loaded). Only static and external can be used |
| | together. |
| Sample- | is the rate at which synchronous data variables are populated. |
| Rate | |
| GDS | is the data source descriptor. This string defines the complete |
| pipe | General Data Server method declaration that is used to retrieve a |
| | data package (parcel) from the target data provider. |

Any number of variables can be defined in a single BeX. Many variables can have the same GDSpipe specification. A locally defined dynamic variables can only be used in the antecedent of a metric rule (state variables appear in the consequent or action part of the rule). The definition of variables is indicated by the VARIABLES keyword in the BeX definition file (not case sensitive). As an example,

VARIABLES {

| | | |
|---|---|---|
| int | iCPUUsed (1000) | RM.GetCPUTime; |
| Static int | iTimesExecuted=0; | |

}

A metric rule instantiates a state variable. State variables are defined in the State Context section of the Behavior Module. The collection of instantiated state variables is used in the behavior rule section. State Variables (or simply States) are explicitly defined before any of the Metric rules. A state variable definition has the form:

StorageType StateType VarId [=InitState] EventThreshold

Where:

| | |
|---|---|
| StorageType | is the optional storage class designator and can take on the same |
| | properties as the locally defined working variables (Dynamic, |
| | External, Shared, or Static). If not specified, Dynamic is assumed. |
| StateType | is the state of the variable. This can be Boolean, Enumerated, or |
| | Fuzzy. Only Boolean states are available in the first release of |
| | Aware. If a StateType is not specified, then Boolean is assumed by |
| | default. |
| VarId | is the name of the state variable. The name can be one to thirty-two |
| | characters in length (and must start with either the underscore or an |
| | alphabetic character). Variable names are not case sensitive. Each |
| | state variable name in the BeX must be unique. If the state name has |
| | the external data storage attribute, it must be declared as shared by |
| | all other BeXs except the one where it is originally defined. A static |
| | and external state can also have an initialization value (this value is |
| | assigned only once - when the BeX is compiled and loaded). Only |
| | static and external can be used together. |
| InitState | The initial or default value of the state. If not specified, then FALSE |
| | is assumed. |
| EventThreshold | The clock as well as sampling density necessary to actually |
| | affect an event transmission. As an example, we might have an |
| | event threshold of (10, 60 sec) meaning that this state variable must |
| | be activated ten times in a sixty second period in order to actually |
| | transmit an event outside Aware. On the other hand, our threshold |
| | might be a simple sampling density (26), in which case the |
| | threshold represents the average of the past 26 values. Note that a |
| | sample of (1) is equivalent to a clock of (1, 0) meaning that the state |
| | variable is activated once in any time period. This is equivalent to a |
| | point sample. If an EventThreshold is not specified then (1) is |
| | assumed as a default. |

State variables provide the connection between metric rules and the behavior rules. Generally, behavior rules operate on the instantiated values of the state variables established by the metric rules. A collection of state variables declared in a BeX could appear as:

STATES {

| | |
|---|---|
| boolean | CPUAlert; |
| | DSKAlert=FALSE; |
| Shared | SystemFault; |

}

Attempting to define an initial value to a shared state is an error. Since the values of the state variables are not established until all the metric rules have been executed, the default value of a state variable can also be the value of a locally defined or shared variable. Aware will perform automatic type casting between variables assuming the data types are translatable.

Metric rules assess the state of the application by evaluating data values against a collection of thresholds or intervals. Metric rules provide a form of mapping between thresholds and State variables (or simply States). This is illustrated schematically as,

$$\begin{matrix}{t}_{1} \to {S}_{1} \\ {t}_{2} \to {S}_{2} \\ ⋮ \\ {t}_{n} \to {S}_{n}\end{matrix}$$

This mapping is done through a collection of procedural rules (by procedural, we mean that the rules are executed in a linear fashion, starting at the first rule and stopping at the last rule.) Each rule that has a true predicate initiates a state variable assignment. A metric rule is in the form:

Ruleid if<VarId rel exp>[and|or]. . . then<s VarId [=|is] sexp>

Ruleid if<Varid rel exp>[and|or]. . . then do;

<sVarId [=|is] sexp>

<Rule>

end if

Where

| | |
|---|---|
| Ruleid | is the unique identifier for this rule in the Metrics section. The |
| | rule identifier can be omitted if not needed (in which case |
| | the metric rules are labeled serially. This means that the first |
| | metric has a Ruleid of M1, the second has a Ruleid of M2, |
| | and so forth.) |
| VarId | is the name of variable defined in the Variables section of the |
| | BeX. The name can be one to thirty-two characters in |
| | length (and must start with either the underscore or |
| | an alphabetic character). |
| | Variable names are not case sensitive. |
| rel | is a relational operator. This is any of the graphic or lexical |
| | representations of the Boolean relationals: equals, less than, |
| | greater than, less than or equal, greater than or equal, |
| | contains, omits. The word not |
| | can be used to generate the complement (as well |
| | as the graphic and lexical for not equal). |
| exp | is a predicate expression involving either arithmetic, |
| | logic and string operators, constants, functions, or other variable |
| | names. Normally this is the constant or variable value |
| | associated with some metric. |
| And\|or | is a logical connector between multiple antecedent |
| | expressions. Any number of expressions can be coupled to form |
| | a valid antecedent to a metric rule. This is often needed |
| | when a state variable is dependent on the |
| | condition of two or more data values (such as CPU |
| | consumption and disk space availability). Parentheses are used |
| | to specify the order of evaluation |
| | (which is normally left to right). |
| SVarId | is the name of a unique state variable in the BeX. |
| | Each state variable is an |
| | extended or interval Boolean variable that |
| | is normally assigned the value |
| | TRUE or FALSE (these are built-in Aware states). |
| Rule | is a nested rule within the do . . . end block. |
| | This rule has the same syntax as the top-level rule. |

Metric rules form the foundation logic of the application management policy. They compare the current state of an application's behavior as well as selected environmental conditions against minimum or maximum or desirable thresholds (or ranges). When a rule antecedent expression is true, the then part (or consequent) of the rule is performed. The consequent set or instantiates the value of one or more state variables. Note that a rule can set multiple state variables or it can apply nest conditionals by enclosing the collection in a do . . . end block. As an example,

METRIC RULES {

If iCPUUsed > 80 then CPUAlert = TRUE;
If iDiskRem < 20 then do;

DSKAlert = TRUE;
If CPUAlert then StablityAlert = TRUE;

End if

}

Behavior rules generally (but not exclusively) work on the pool of state variables established by the Metric Rules. In this discussion we concentrate on the use of States, however, a behavior rule can also interrogate BeX Objects—variables, states, and rules contained in shared or dependent Behavior Modules. This use of Behavior rules is discussed later in the document. Cast in the form of if-then rules, behavior rules provide a functional mapping between collections of states to a unique event. This is illustrated schematically as,

f(Sₜ,Sₖ, . . . , S_{z})→Eⱼ

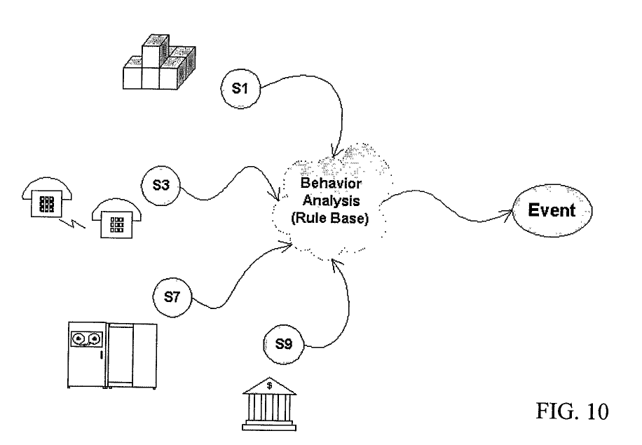

The purpose behind behavior rules is simple: analyze the collective state of the system and threw an event if the state is outside the performance model established by either a single behavior rule or a set of behavior rules. As FIG. 10 illustrates, the behavior rules synthesize a set of states into an analysis of over-all performance and send an event when the performance is at variance with the prescribed behavior.

Like the metric rules, evaluation is done through a collection of procedural rules (by procedural, we mean that the rules are executed in a linear fashion, starting at the first rule and stopping at the last rule.) Each rule that has a true predicate initiates a possible set of actions. A behavior rule is in the form:

Ruleid [Frequency—f, Severity=n]

if<BeXObject rel exp>[and|or]. . . then<action>

Ruleid [Frequency=f,Severity=n]

if<BeXObject rel exp>[and|or]. . . then do;

<action>

<Rule>

end if

Where

| | |
|---|---|
| Ruleid | is the unique identifier for this rule in the Behaviors section. Each |
| | behavior rule must have an associated rule identifier. This rule |
| | identifier is used in the automatic tracking facility, the agenda |
| | manager, and the event protocol dispatcher. |
| Frequency | is an integer value in the range [0, n]. Where “n” can be an |
| | arbitrarily (but not unreasonably) large number. The frequency |
| | attribute indicates how often, in seconds, the rule will be fired. Thus |
| | freq = 10 indicates that the rule is fired every ten seconds. When |
| | freq = 0, the rule is fired continuously. When freq = −1, the rule is |
| | disabled. |
| Severity | is a rating between [0, 1]. Zero indicates an information level rule |
| | only. A one indicates a rule reflecting a fatal condition in the |
| | application (or a condition that can lead to application instability). If |
| | not specified then [.5] is assumed. bAware aggregates the severity |
| | level of incoming rules form the same BeX. |
| BeXObject | Any local Variable (a VarId) or any properly qualified object drawn |
| | from the dynamic pool of active Behavior Modules (all the related |
| | Behavior Execution Modules or BeXs). Generally, for a self- |
| | contained BeX, the object is a VarId - the name of any variable |
| | defined in the Variables section or any state variable defined in the |
| | State section of the BeX. Although the Behavior Rules are intended |
| | to access the state variables (and thus focus on the performance of |
| | the application or system), they are capable of interrogating any of |
| | the variables defined in the BeX. |
| rel | is a relational operator. This is any of the graphic or lexical |
| | representations of the Boolean relationals: equals, less than, greater |
| | than, less than or equal, greater than or equal, contains, omits. The |
| | word not can be used to generate the complement (as well as the |
| | graphic and lexical for not equal). |
| exp | is a predicate expression involving either arithmetic, logic, and |
| | string operators, constants, functions, or other variable names. |
| | Normally this is the constant or variable value associated with some |
| | metric. |
| And\|or | is a logical connector between multiple antecedent expressions. Any |
| | number of expressions can be coupled to form a valid antecedent to |
| | a metric rule. This is often needed when an action is dependent on |
| | the condition of two or more data values (such as CPU consumption |
| | and disk space availability). Parentheses are used to specify the |
| | order of evaluation (which is normally left to right). |
| action | is the result of evaluating and executing a true rule. Unlike the |
| | metric rules, which can only set the value of a State variable, the |
| | behavior rules can perform a variety of actions. Some of the actions |
| | include, |
| SendEvent | Forms and transmit a general event message to the designated |
| | receptor site. Sending an event is the principal type of action |
| | employed by the behavior rules and the general method of |
| | communicating with the outside world. The first parameter in the |
| | SendEvent action indicates the intended receiver. This is used to |
| | discriminate between hidden, local and external event patterns. |
| | Thus, |
| | SendEvent (Netscape, . . . ) |
| | Sends an event to the Netscape BeX on the local machine. Since |
| | this is a BeX-to-BeX communication, the event is automatically |
| | hidden. |
| | SendEvent (LECO_NT1, . . . , ) |
| | Sends an event to the local ecology scheduler on the current |
| | machine. This generates a Local event. A local event might be |
| | stored and forwarded by the target LECO. |
| | SendEvent (bAware, . . . ) |
| | SendEvent (GECO_SOLARIS8, . . . ) |
| | Generates and sends an external event to either the bAware front |
| | end or to the designated (and remote) global ecology scheduler. |
| ApplyRule | Explicitly executes the specified rule. |
| WriteLog | Writes a line to the Aware audit tracking and logging file. Issues an |
| | automatic commit. |
| AcquireData | Connects to the GDS and retrieves another package (parcel) of data. |
| ExecScript | Runs the named script |
| | A behavior rule can also change the value of some other variable |
| | through a simple assignment statement. Thus, if the thresholds are |
| | stored in locally defined (or external) variables, a behavior rule can |
| | change its own (or another BeX's) policy thresholds (or intervals). |
| Rule | is a nested rule within the do . . . end block. This rule has the same |
| | syntax as the top-level rule. |

Behavior rules form the core of the application management policy. They integrate the states of the metric variables (the state variables) into a logical edifice expressing a model of the application's preferred behavior (as one possible example). Behavior rules provide the policy analyst with the tools necessary to trap anomalous behavior, filter events, transmit events into the outside world, and modify its own operation. When a rule antecedent expression is true, the then part (or consequent) of the rule is performed. The consequent initiates one or more actions. Note that a rule can perform multiple actions or it can apply nested conditionals by enclosing the collection in a do . . . end block. As an example,

BEHAVIOR RULES {

MyRule1. [Freg=10] If CPUAlert and DSKAlert then do;

ExecScript “FreeTempSpace”
If ExecScript.Status>0 then do ;

SendEvent (bAware, aCRITICAL, INSUFFICIENT_RESOURCES, &AppName);

End if

End if

}

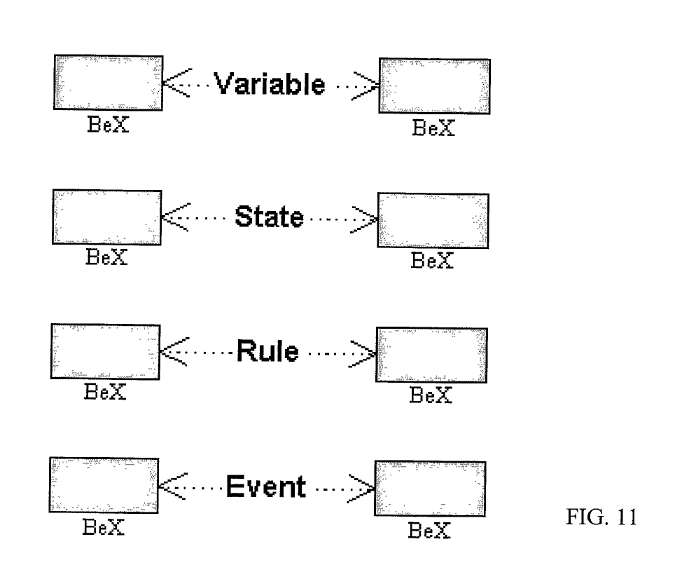

Individual BeXs are connected to an application. They measure the performance of the application against a series of baseline metrics. When a metric threshold is violated, a state variable is set. The behavior rules examine the collection of state variables to see if some action should be initiated (such as throwing an event). The internal state of a BeX (the values of its variables, the condition of its States, the execution status of its rules, and the nature of its event schedule) can be shared among other BeXs. As FIG. 11 illustrates, the relationships (or dependencies) between BeXs can be expressed using a wide variety of the internal controls.

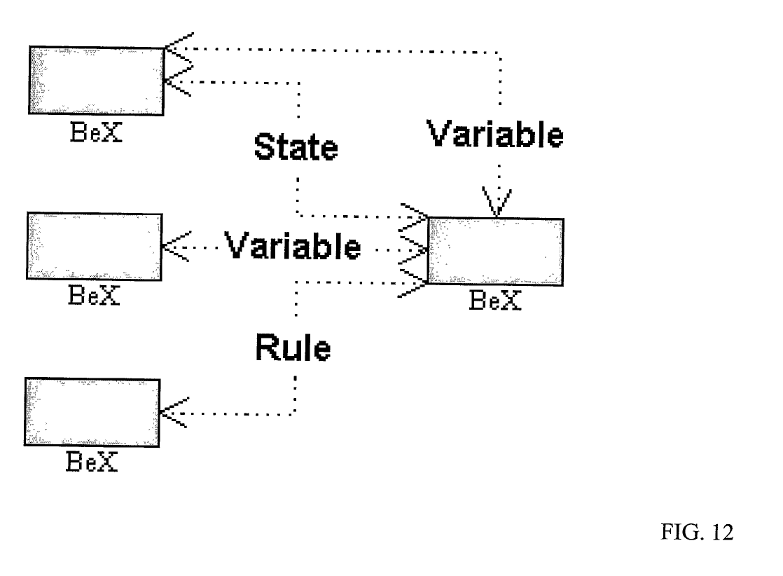

Thus, if two behavior modules share a common State (one owns the state variable, the other has access to its value) they are explicitly linked through this common state. The one that shares the state is the dependent BeX, the one that owns the state is the independent BeX. Sharing the current value of variables, the state of one or more rules, and the type or value of a scheduled event can also entangle behavior modules. And, as FIG. 12 illustrates, a many to one (n: 1) dependency relationship can be created through multiple types of shared objects.

FIG. 12 also illustrates schematically two other fundamental concepts in building the dependency network: bi-directionality and multiple dependency points. Bi-directional linkages mean that an independent BeX can also gain access to the control structures associated with its parent (dependent) BeX. This has significant implications for knowledge modeling as well as mechanizing the adaptive feedback tuner. Multiple dependency points simply means that a dependent BeX can be linked to one or more other BeXs through more than one control mechanism (such as through State variables and Rules or State variables and ordinary variables).

The effector relationship linkages for a dependency matrix are established through the dependent or independent BeXs behavior rules. This means that the behavior rules can use the shared variables by qualifying the names with the name of the associated (owning) BeX. As an example, consider the following behavior rule,

If b1.s1 and b3.r1 and b3.r4 and not b5.s3 then

If this.s2 and this.s7 then

SendEvent(myevent)

Endif

End if

Which says (in part): if state variable s1 in BeX b1 is true (it was set by the tripping of an associated metric rule) and rule r1 in BeX b3 was fired and rule r4 in the same BeX (b3) was fired but state variable s3 in BeX b5 is not true (that is, it's false) then execute this rule. This is a nested rule which then says: if local state variable s2 and local state variable s7 are true then send an event. The qualification “this” indicates that the object is a member of the current BeX. When no ambiguity exists between local and shared variables, the “this” qualifier can be dropped (although it is not an error to use it). In order to actually use shared control mechanisms, the names of the independent Behavior Modules must be specified in the DEPENDENCIES statement of the current (dependent) Behavior Module. This concept is discussed below.

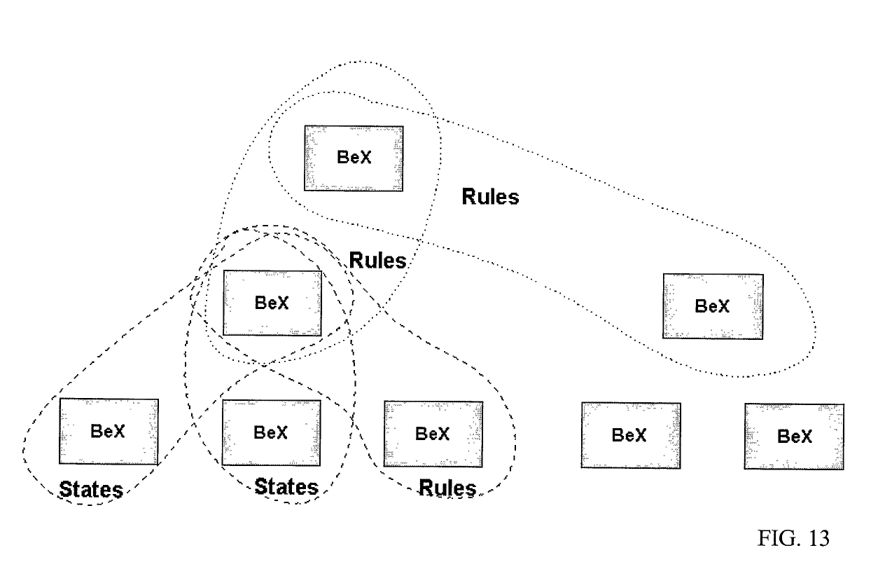

As FIG. 13 illustrates, sharing control mechanisms creates an explicit (an implicit) dependency among Behavior Modules. In this diagram, a hierarchal or tiered architecture is created. Each dependent behavior Module interrogates the control mechanisms of the BeXs “below” it on the tree.

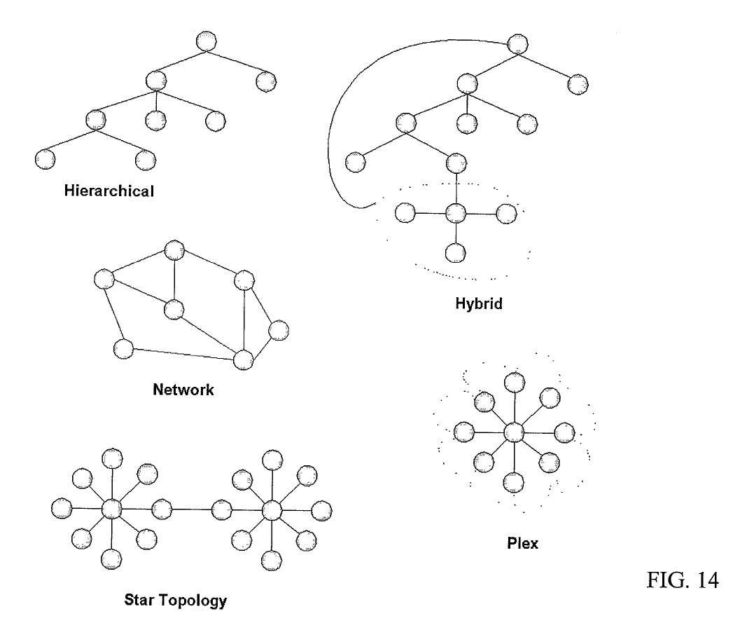

The actual architecture (more properly, the topology) of a Behavior Module network is synthesized out of the composite control mechanisms shared among the Behavior Modules and the ways in which the behavior rules use and set the shared objects. FIG. 14 illustrates some example topologies.

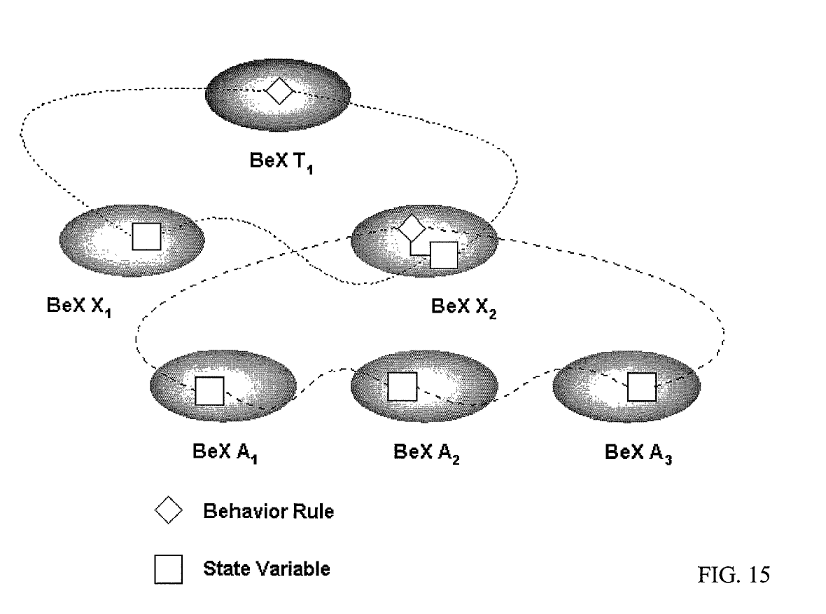

Each topology represents a type of deployed meta-control architecture. Because dependencies are specified only at the parent-child level (not across the entire topology), we can easily modify the deployed architecture. This means that BeX topologies can evolve from simple to more complex structures as the need arises. Dependency networks allow us to build Behavior Modules that analyze the states of multiple applications (or multiple tasks). FIG. 15, as an example, illustrates a tiering of Behavior Modules based on State variables.

In FIG. 15, we see that BeX X₂ has a behavior rule that uses State variables from three other BeXs. Accessing external state variables in other Behavior Modules provides a powerful and flexible and robust method of building complex, multi-tired management and analysis systems that can observe the behavior of large, complex systems. Using shared state variables a higher level BeX can detect anomalous or performance-specific conditions that are distributed across many applications. You should also note that the definition of “higher” and “lower” level is relative to the BeX's dependency relationships.

To use shared state variables three design conditions must be met: the state variables in the low level BeX must be declared as External, the same state variables must be defined as Shared in the higher level BeX, and the low level (or dependent) BeXs must appear in the higher level BeX's dependency (or topology) declaration. A BeX with shared. The following illustrates a Behavior Module with shared state variables and a rule that uses them.

| | |
|---|---|
| BeXID: | MyBeX |
| CREATED: | 10MAY00 15:18:12 |
| PROCESS: | C: \SVER01\SAP2\I\SHOES.EXE |
| DEPENDENT: | UrBeX, ThisBeX, ThatBeX, AnudderBeX |
| // | |
| STATES { | |

| | |
|---|---|
| Shared Boolean | QueueAlert |
| Shared Boolean | ThatBeX (ResponseAlert) |
| Shared Boolean | PagingAlert |
| Boolean | CPUAlert |
| Boolean | DISKAlert |

}
VARIABLES {

| | | |
|---|---|---|
| int | iCPUUsed | RM.GETCPUTIME |
| int | iDiskRem | RM.GETDISKLEFT |

}
METRIC RULES {

If iCPUUsed > 80 then CPUAlert = TRUE;
If iDiskRem < 20 then DISKAlert = TRUE;

}
BEHAVIOR RULES {

SysRule01. If CPUAlert and QueueAlert but not PagingAlert then

Send Event (bAware, SysRule01, aCRITICAL, INSUFFICIENT-RESOURCES, &AppName);
End if

}

An independent BeX can expose state variables in another BeX through an explicit declaration. This is illustrated in the declaration of the state variable ResponseAlert. By explicitly qualifying the variable name with the name of the BeX, we cause the target state variable to be prompted to a storage type of External. You can use this state just like any other state unless another shared state has the same name. In this case, the exposed state must be qualified (ThatBeX.ResponseAlert).

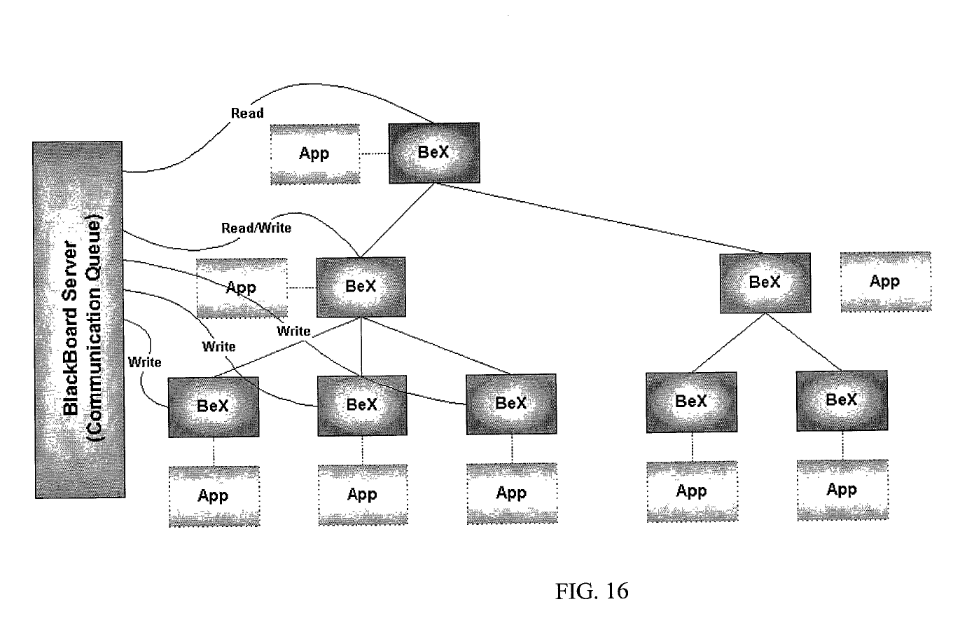

FIG. 16 shows a mechanism in which BeXs may share information through a blackboard server. Each BeX may read or write information to the blackboard.

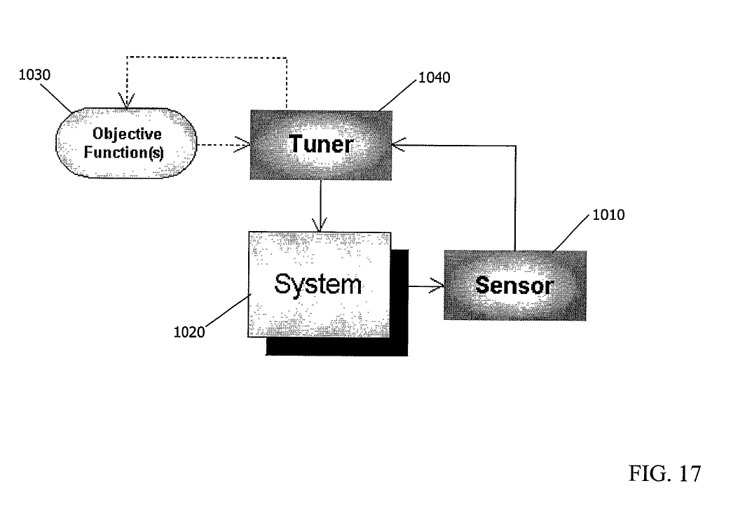

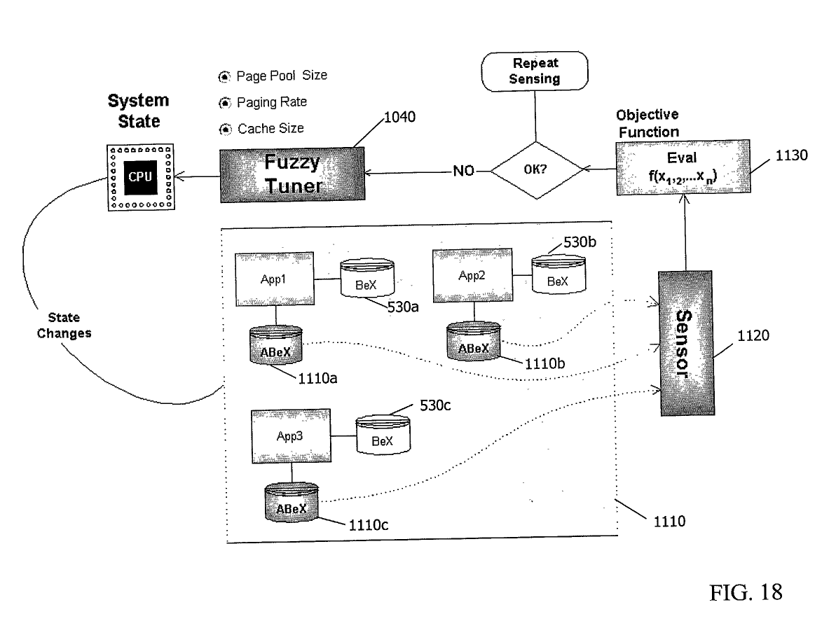

A BeX may be used for special functions. For example, a specially coded BeXs called Adaptive-Support Behavior Modules (or ABeX) may be used for adaptive feedback control. Adaptive feedback control may be a top down process. FIG. 17 shows a general block diagram of adaptive feedback. System 1020 represents a collection of BeXs. A sensor array 1010 may observe and record how system 1020 reacts to different situations in service management. Such sensor data is sent to a tuner 1040. Tuner 1040 is equipped with a set of objective functions that are related to expected system performance. If the recorded data about system 1020 does not match with the objective functions, tuner 1040 initiates adaptive feedback control to tune system 1020. The tuning may be achieved by forcing the BeXs in system 1020 to revise the rules that are related to unsatisfactory performance. This process can be seen in more detail from FIG. 18.

In FIG. 18, system 1020 comprises, for example, three BeXs, 530a, 530b, and 530c, each of which is attached to an infrastructure component. In addition to these monitoring BeXs, a set of specially coded BeXs called adaptive-support BeXs or AbeXs, 1110a, 1110b, 1110c, are used for adaptive feedback control. Each of ABeXs comprises inter-connected external (shared) state variables that can be accessed by sensor 1010. Data from sensor 1010 is evaluated by an evaluator 1030 against a set of objective functions. The objective functions may be multiple dimensioned. The evaluation may be performed by computing a set of Euclidean distance between the sensed states and the target states (specified by the objective functions). The distance is used to determine the adjustment to be made. Tuner 1040 sends adjustments back to the associated BeXs to update their internal states.

The plant tuner is a fuzzy logic controller. The controller consists of fuzzy if-then rules (arranged in a connectionist architecture representing a state transition machine). Each ABeX contains a collection of fuzzy rules, which measure the performance of the system and report the degree of compatibility with the objective function (themselves organized as fuzzy numbers). Fuzzy rules employ variable window lad horizons so that changes in the system state can be accurately measured. Quantification of the objective function is achieved through several steps:

Centroid defuzzification of outcome space

Conversion of the defuzzified outcome to a fuzzy number with the appropriate expectancy interval

Comparison with fuzzy objective using inverse of Euclidean distance as the similarity measurement control.

Run fuzzy rule base with each similarity coefficient to determine how to adjust machine parameters.

Nearly all the state variables in the ABeX systems are shared. These variables are identified by the leading underscore in their name (_CPUAlert).

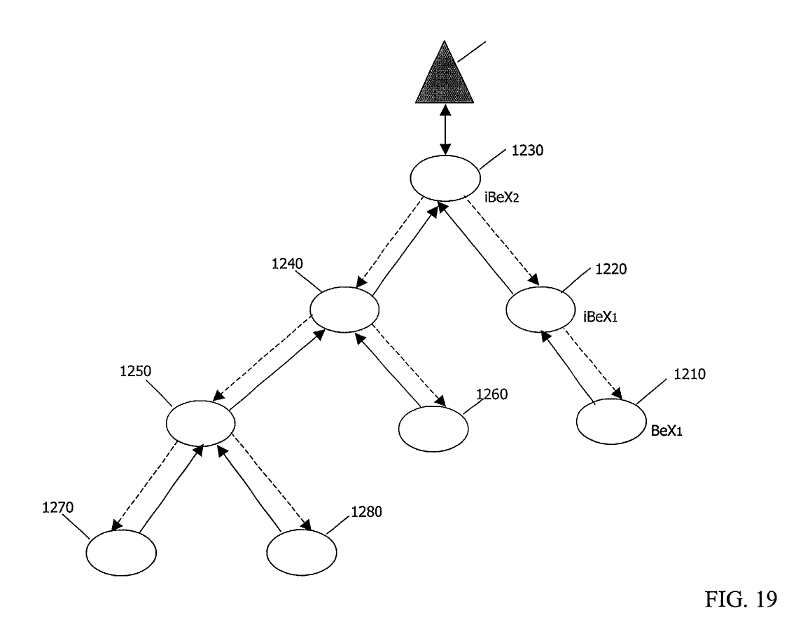

Sensor 1010, tuner 1040, and the evaluator 1040 may reside in a BeX where the adaptive feedback control is initiated. FIG. 19 shows an exemplary adaptive feedback control among a set of BeXs. In FIG. 19, BeX₁ 1210 is attached to an infrastructure component, for example, an application that computes the trend of a stock price. When the memory use of this particular application goes up to 35% on a local system, it may trigger a particular behavior rule. Since at component level, BeXₗ has no knowledge about the higher level business need for the capacity of the memory of this local system, it has no way to know what kind of impact this abnormal behavior will cause on the overall eService performance. So, the behavior rule associated with this stock price application may conservatively trigger an action to simply report this abnormal behavior to a higher level BeX.

Based on the behavior rule of BeXₗ, this abnormal event is reported to an integration BeX 1220, located, for example, in local ecology pattern detector. The local integration BeX 1220 may still not have enough business process knowledge to estimate the severity of this particular abnormality with respect to the eService. So, it may further 20 forward the event to a global integration BeX 1230, which may be located in a global ecology controller. Since BeX 1230 sits at the eService level, it is equipped with the knowledge about the business process of eService. Based on such knowledge and the reported events from all parts of the eService infrastructure (BeXs 1240, 1250, 1260, 1270, and 1280), it may estimate or detect a significant performance degradation at 25 eService level. By analyzing the reported abnormal events, BeX 1230 may decide that the major factor responsible for the overall performance degradation is the lack of memory space at the system where the stock price application is running. It may further identify that lack of memory is due to the fact (according to the event reported from BeXₗ 1210) that a particular application has used up a large chuck of memory on that system and caused shortage of the memory. In addition, it may recognize that 1210 and 1220 are the BeXs that are responsible for that particular application.

The unexpected performance degradation and the identified cause may trigger BeX 1230 to decide that adaptive feedback control is necessary. Since it is clear at this point that BeXₗ, who is directly responsible for the faulty application, and all the BeXs that simply routed the information about the abnormal behavior of the faulty application fail to realize the severity of the misbehavior, iBeX 1230 initiates adaptive tuning by sending an updated rule to both BeX 1220 and BeX 1210. The rule is to be used to replace the conservative behavior rules that are previously used by both BeXs 1210 and 1220 regarding this particular behavior.

In the updated rule, it may explicitly indicate that if the memory usage of any single application exceeds 30%, then the application should be re-ranked with a much lower priority. It is also possible to simply instruct to kill such applications. The former strategy provides more space to conduct incremental learning. It is also possible for BeX 1230 to initiate a feedback control by sending a generic behavior rule to all the BeXs (1210, 1220, 1240, 1250, 1260, 1270, 1280) that restricts the use of any application at any time instance to maximum of 20% of total memory capacity.

Adaptive feedback control can be performed within different scopes. While the example shown in FIG. 14 is from the eService level all the way down to component level, it is also possible to initiate from local ecological level to component level or even among component level BeXs. It is flexible, dynamic, and learning based. It may be initiated when an unexpected performance degradation is due to the misjudgment from BeXs due to inexperience. It may be initiated because of other reasons. With the capability of self-adapting, the entire eSerive management system 100 is capable of continuous evolving, during its operation and based on accumulated experience, towards an optimal performance state.

what is claimed is:

1. A method for determining, by a behavior expert, the performance of an infrastructure component based on the operational information relevant to the performance of said infrastructure component, said method comprising:
obtaining said operational information, from at least one data provider connected to said infrastructure component, said operational information providing values for a set of variables that are used to define the performance of said infrastructure component;
transforming zero or more states, controlled by said behavior expert, according to a set of metric rules, employed by said behavior expert, based on the values of said set of variables; and
generating zero or more events, indicating the performance of said infrastructure component, according to a set of behavior rules, employed by said behavior expert, based on said states transformed by said transforming.

2. The method according to claim 1, wherein each of said metric rules includes an if-then statement, relating a set of variables to a set of states, where the if-condition of said if-then statement is expressed as relations between said set of variables and their values and where the actions of said if-then statement describe said set of states to be transformed, when the if-condition of said metric rules is satisfied, and the manner the set of states to be transformed.

3. The method according to claim 1, wherein each of said behavior rules includes an if-then statement, relating a set of states to a set of events, where the if-condition of said if-then statement is expressed with respect to said set of states and the actions of said if-then statement describe the set of events to be generated when the if-condition of said behavior rules is satisfied.

4. The method according to claim 2, wherein said if-condition includes at least one of:
a quantitative condition expressed as at least one relation between a variable and its corresponding quantitative value;
a qualitative condition expressed as at least one relation between a variable and its corresponding qualitative value; and
a combination of quantitative and qualitative condition which includes at least one quantitative condition and at least one qualitative condition.

5. The method according to claim 4, wherein said quantitative value include at least one of a numerical value, a Boolean value, and a string value.

6. The method according to claim 4, wherein said qualitative value includes at least one of a linguistic qualifying term represented by a fuzzy set.

7. The method according to claim 1, further comprising:
declaring zero or more elements of said behavior expert as public elements so that said elements can be accessed by different behavior experts; and
specifying zero or more different behavior experts as the dependencies of said behavior expert so that the elements declared by said different behavior experts as public elements can be accessed by said behavior expert.

8. The method according to claim 7, wherein said elements include at least one of a state, an event, and a fuzzy set.

9. The method according to claim 1, further comprising:
forming uniform event representation for said events, generated by said generating, in accordance with a standard format; and
posting said uniform event representation of said events in an event pool.

10. The method according to claim 1, wherein said at least one data provider includes at least one of a service, an operating system, an application, an external transaction, a network, and a behavior expert.

11. A behavior expert system for determining the performance of an infrastructure component based on the operational information relevant to the performance of said infrastructure component, said system comprising:
an acquisition mechanism for obtaining said operational information, from at least one data provider connected to said infrastructure component, said operational information providing values for a set of variables that are used to define the performance of said infrastructure component;
a state transformation unit for transforming zero or more states according to a set of metric rules based on the values of said set of variables; and
an event generation unit for generating zero or more events, indicating the performance of said infrastructure component, according to a set of behavior rules, based on said states transformed by said state transformation unit.

12. The system according to claim 10, further comprising:
an output port for exporting zero or more elements of said behavior expert system as public elements so that said elements can be accessed by different behavior expert systems; and
an input port for importing zero or more elements from different dependent behavior expert systems wherein said zero or more elements are declared as public elements by said different behavior expert systems.

13. The system according to claim 11, wherein said elements include at least one of a state, an event, and a fuzzy set.

14. The system according to claim 10, further comprising:
an event representation generator for constructing uniform event representations for said events, generated by said event generation unit, in accordance with a standard format; and
a posting mechanism for posting said uniform event representations of said events in an event pool.

15. The system according to claim 13, wherein said standard format includes a uniform data model.

16. The system according to claim 10, wherein said event pool includes a blackboard.

17. A computer-readable medium encoded with a program for determining the performance of an infrastructure component based on the operational information relevant to the performance of said infrastructure component, said program comprising:
obtaining said operational information, from at least one data provider connected to said infrastructure component, said operational information providing values for a set of variables that are used to define the performance of said infrastructure component;
transforming zero or more states, controlled by said behavior expert, according to a set of metric rules, employed by said behavior expert, based on the values of said set of variables; and
generating zero or more events, indicating the performance of said infrastructure component, according to a set of behavior rules, employed by said behavior expert, based on said states transformed by said transforming.

18. The computer-readable medium according to claim 16, wherein said at least one data provider includes at least one of a service, an operating system, an application, an external transaction, a network, and a behavior expert.

19. The computer-readable medium according to claim 16, wherein each of said metric rules includes an if-then statement, relating a set of variables to a set of states, where the if-condition of said if-then statement is expressed as relations between said set of variables and their values and where the actions of said if-then statement describe said set of states to be transformed, when the if-condition of said metric rules is satisfied, and the manner the set of states to be transformed.

20. The computer-readable medium according to claim 1, wherein each of said behavior rules includes an if-then statement, relating a set of states to a set of events, where the if-condition of said if-then statement is expressed with respect to said set of states and the actions of said if-then statement describe the set of events to be generated when the if-condition of said behavior rules is satisfied.

21. The computer-readable medium according to claim 18, wherein said if-condition includes at least one of:
a quantitative condition expressed as at least one relation between a variable and its corresponding quantitative value;
a qualitative condition expressed as at least one relation between a variable and its corresponding qualitative value; and
a combination of quantitative and qualitative condition which includes at least one quantitative condition and at least one qualitative condition.

22. The computer-readable medium according to claim 20, wherein said quantitative value include at least one of a numerical value, a Boolean value, and a string value.

23. The computer-readable medium according to claim 20, wherein said qualitative value includes at least one of a linguistic qualifying term represented by a fuzzy set.

24. The computer-readable medium according to claim 1, said program further comprising:
declaring zero or more elements of said behavior expert as public elements so that said elements can be accessed by different behavior experts; and
specifying zero or more different behavior experts as the dependencies of said behavior expert so that the elements declared by said different behavior experts as public elements can be accessed by said behavior expert.

25. The computer-readable medium according to claim 23, wherein said elements include states, events, and fuzzy sets.

26. The computer-readable medium according to claim 1, said program further comprising:
forming uniform event representation for said events, generated by said generating, in accordance with a standard format; and
posting said uniform event representation of said events in an event pool.

27. The computer-readable medium according to claim 25, wherein said standard format includes a uniform data model.

28. The computer-readable medium according to claim 25, wherein said event pool includes a blackboard.

29. The method according to claim 3, wherein said if-condition includes at least one of:
a quantitative condition expressed as at least one relation between a variable and its corresponding quantitative value;
a qualitative condition expressed as at least one relation between a variable and its corresponding qualitative value; and
a combination of quantitative and qualitative condition which includes at least one quantitative condition and at least one qualitative condition.

30. The computer-readable medium according to claim 19, wherein said if-condition includes at least one of:
a quantitative condition expressed as at least one relation between a variable and its corresponding quantitative value;
a qualitative condition expressed as at least one relation between a variable and its corresponding qualitative value; and
a combination of quantitative and qualitative condition which includes at least one quantitative condition and at least one qualitative condition.
